(19) United States
(12) Patent Application Publication
(10) Pub. No.: US 2015/0024191 A1
(43) Pub. Date: Jan. 22, 2015

(54) Reflection-Resistant Glass Articles and Methods for Making and Using Same

(71) Applicant: CORNING INCORPORATED, CORNING, NY (US)

(72) Inventors: Melissa Danielle Cremer, Seattle, WA (US); Steven Bruce Dawes, Corning, NY (US); Shandon Dee Hart, Corning, NY (US); Lisa Ann Hogue, Corning, NY (US)

(21) Appl. No.: 14/371,261

(22) PCT Filed: Jan. 11, 2013
(86) PCT No.: PCT/US2013/021116

§ 371 Date: Jul. 9, 2014

Related U.S. Application Data
(60) Provisional application No. 61/586,229, filed on Jan. 13, 2012.

(51) Int. Cl. C03C 17/30; C03C 23/00; G02B 1/12; C03C 17/23; G02B 1/11

(52) U.S. Cl. CPC C03C 17/30; C03C 17/23; G02B 1/113; G02B 1/12; C03C 23/007; C03C 2217/732; C03C 2217/213; C03C 2217/425
USPC 428/312.6; 428/315.7; 427/165

(57) ABSTRACT

Described herein are coated glass or glass-ceramic articles having improved reflection resistance. Further described are methods of making and using the improved articles. The coated articles generally include a glass or glass-ceramic substrate and a nanoporous Si-containing coating disposed thereon. The nanoporous Si-containing coating is not a free-standing adhesive film, but a coating that is formed on or over the glass or glass-ceramic substrate.

### CROSS-REFERENCE TO RELATED APPLICATIONS

This application claims the benefit of priority of U.S. Provisional Patent Application Ser. No. 61/586,229 filed on 13 Jan. 2012, the contents of which are relied upon and incorporated herein by reference in their entirety as if fully set forth below.

### TECHNICAL FIELD

The present disclosure relates generally to reflection-resistant or anti-reflection coatings. More particularly, the various embodiments described herein relate to glass or glass-ceramic articles having nanoporous coatings disposed thereon such that the coated articles exhibit improved reflection resistance, as well as to methods of making and using the coated articles.

### BACKGROUND

Anti-reflection technologies are necessary in a variety of applications to reduce the reflection of light from surfaces and/or improve the transmission of light through surfaces. To illustrate, light from an external light source that is incident on a given surface can be reflected from the surface, and the reflected light image can adversely affect how well a person perceives the underlying surface and contents thereof. That is, the reflected image overlaps the image from the underlying surface to effectively reduce the visibility of the underlying surface image. Similarly, when the incident light is from an internal light source, as in the case of a backlit surface, the internal reflection of light can adversely affect how well a person perceives the surface and contents thereof. In this case, the internally reflected light reduces the amount of total light that is transmitted through the surface. Thus, reflection-resistant or anti-reflection technologies are needed to minimize external and/or internal reflection of light so as to enable a surface to be seen as intended.

To combat the deleterious effects of increased reflectance and/or decreased transmission in the electronics display industry, various anti-reflection technologies have been developed. Such technologies have involved the use of adhesive films that are directly applied to the surfaces of the display screens or windows to provide reflection-resistant surfaces. In certain cases, these adhesive films can be coated with additional multiple index interference coatings that prevent reflections from the screen. Unfortunately, during application of the adhesive films, air is often trapped between the display screen and the film This results in air pockets that are unsightly and prevent the display image from being seen properly. In addition, such films can be scratched easily during use, and thus lack the durability needed to withstand prolonged use.

Rather than focus on adhesive films, alternative anti-reflection technologies have implemented coatings that are disposed directly on the display surfaces. Such coatings avoid the issues associated with air pockets being created during application, but do not necessarily provide improved durability. For example, some existing polymer-based anti-reflection coatings, such as fluorinated polymers, can have poor adhesion to glass and/or low scratch resistance. In addition, when applied to chemically-strengthened glasses, certain currently-existing coating technologies can actually decrease the strength of the underlying glass. For example, sol-gel-based coatings generally require a high-temperature curing step (i.e., greater than or equal to about 400 degrees Celsius (° C.)), which, when applied to a chemically-strengthened glass after the strengthening process, can reduce the beneficial compressive stresses imparted to the glass during strengthening.

There accordingly remains a need for improved anti-reflection technologies that do not suffer from the drawbacks associated with currently-existing technologies. It is to the provision of such technologies that the present disclosure is directed.

### BRIEF SUMMARY

Described herein are various articles that have anti-reflection properties, along with methods for their manufacture and use. The anti-reflection properties are imparted by way of nanoporous coatings that are disposed on (at least a portion of) a surface of the articles.

One type of coated article includes a glass or glass-ceramic substrate and a nanoporous Si-containing coating having an average thickness of less than or equal to about 1 micrometer disposed on at least a portion of a surface of the glass or glass-ceramic substrate. The nanoporous Si-containing coating can have a porosity comprising at least 5 volume percent of a total volume occupied by the nanoporous Si-containing coating. An average longest cross-sectional dimension of pores in the nanoporous Si-containing coating can be less than or equal to about 100 nanometers. The coated article can have a specular reflectance that is less than or equal to about 85 percent of a specular reflectance of the glass or glass-ceramic substrate alone across a visible light spectrum. The nanoporous Si-containing coating has a specular reflectance of less than 5 percent across the visible light spectrum.

In certain implementations, the coated article can further include an intermediate layer interposed between the glass or glass-ceramic substrate and the nanoporous Si-containing coating. This intermediate layer can have a glare-resistant coating, a color-providing composition, an opacity-providing composition, or an adhesion or compatibility promoting composition.

In some cases, the glass or glass-ceramic substrate comprises a silicate glass, borosilicate glass, aluminosilicate glass, or boroaluminosilicate glass, which optionally comprises an alkali or alkaline earth modifier. In other situations, the glass or glass-ceramic substrate can be a glass-ceramic comprising a glassy phase and a ceramic phase, wherein the ceramic phase comprises β-spodumene, β-quartz, nepheline, kalsilite, or carnegieite.

In certain implementations of the coated article, the glass or glass-ceramic substrate has an average thickness of less than or equal to about 2 millimeters.

The nanoporous Si-containing coating can comprise a cured siloxane, a cured silsesquioxane, or silica.

In certain uses, the coated article can serve as a portion of a touch-sensitive display screen or cover plate for an electronic device, a non-touch-sensitive component of an electronic device, a surface of a household appliance, or a surface of a vehicle component.

Another type of coated article can include a chemically-strengthened alkali aluminosilicate glass substrate and a nanoporous Si-containing coating having an average thickness of less than or equal to about 100 nanometers disposed directly on at least a portion of a surface of the chemically-strengthened alkali aluminosilicate glass substrate. The chemically-strengthened alkali aluminosilicate glass substrate can have a compressive layer having a depth of layer greater than or equal to 20 micrometers exhibiting a compressive strength of at least 400 megaPascals both before and after the nanoporous Si-containing coating has been disposed thereon. The nanoporous Si-containing coating can have a porosity comprising between about 30 volume percent and about 55 volume percent of a total volume occupied by the nanoporous Si-containing coating. An average longest cross-sectional dimension of the pores in the nanoporous Si-containing coating can be less than or equal to about 50 nanometers. The coated article can have a specular reflectance of less than 7 percent across a visible light spectrum, an optical transmission of at least about 94 percent, a haze of less than or equal to about 0.1 percent when measured in accordance with ASTM procedure D1003, and/or a scratch resistance of at least 6H when measured in accordance with ASTM test procedure D3363-05.

In certain implementations of this type of coated article, the specular reflectance of the coated article can vary by less than about 5 percent after 100 wipes using a Crockmeter, and can vary by less than about 10 percent after 5000 wipes using the Crockmeter from an initial measurement of the specular reflectance of the coated article before a first wipe using the Crockmeter.

One type of method of making a coated article can include providing a glass or glass-ceramic substrate, preparing a solution comprising a Si-containing coating material and a pore forming agent, wherein the solution comprises no colloidal particles or aggregates having a longest cross-sectional dimension greater than about 75 nanometers, disposing the solution on a surface of the glass or glass-ceramic substrate, and heating the solution-coated substrate at a temperature of less than or equal to about 350 degrees Celsius to both cure the Si-containing coating material and remove the pore forming agent from the solution, thereby forming a nanoporous Si-containing coating on the surface of the glass or glass-ceramic substrate.

The method can further include forming an intermediate layer on at least a portion of the surface of the glass or glass-ceramic substrate prior to disposing the solution thereon, wherein the intermediate layer comprises glare-resistant coating, a color-providing composition, an opacity-providing composition, or an adhesion or compatibility promoting composition.

The nanoporous Si-containing coating formed by this type of method can have a porosity comprising at least 5 volume percent of a total volume occupied by the nanoporous Si-containing coating, an average longest cross-sectional dimension of pores in the nanoporous Si-containing coating less than or equal to about 100 nanometers, and/or a specular reflectance that is less than or equal to about 85 percent of a specular reflectance of the glass or glass-ceramic substrate alone across a visible light spectrum. In addition, the specular reflectance of the coating itself can be less than 5 percent across the visible light spectrum.

The Si-containing coating material can include an uncured or partially-cured siloxane, an uncured or partially-cured silsesquioxane, or a silica sol-gel precursor. Similarly, the nanoporous Si-containing coating can include a cured siloxane, a cured silsesquioxane, or silica.

It is to be understood that both the foregoing brief summary and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 graphically illustrates the specular reflectance of various articles in accordance with EXAMPLES 1 and 2.

These and other aspects, advantages, and salient features will become apparent from the following detailed description, the accompanying drawings, and the appended claims.

### DETAILED DESCRIPTION

Referring now to the figures, wherein like reference numerals represent like parts throughout the several views, exemplary embodiments will be described in detail. Throughout this description, various components may be identified having specific values or parameters. These items, however, are provided as being exemplary of the present disclosure. Indeed, the exemplary embodiments do not limit the various aspects and concepts, as many comparable parameters, sizes, ranges, and/or values may be implemented. Similarly, the terms “first,” “second,” “primary,” “secondary,” “top,” “bottom,” “distal,” “proximal,” and the like, do not denote any order, quantity, or importance, but rather are used to distinguish one element from another. Further, the terms “a,” “an,” and “the” do not denote a limitation of quantity, but rather denote the presence of “at least one” of the referenced item.

Described herein are various coated articles that have improved reflection resistance, along with methods for their manufacture and use. As used herein, the terms “anti-reflection” or “reflection-resistant” generally refer to the ability of a surface to resist specular reflectance of light that is incident to the surface across a specific spectrum of interest.

In general, the improved articles include a glass or glass-ceramic substrate and a nanoporous coating disposed directly or indirectly thereon. The nanoporous coatings beneficially provide the articles with improved reflection resistance across at least the visible light spectrum (i.e., light having a wavelength of about 380 nanometers (nm) to about 750 nm) relative to similar or identical articles that lack the nanoporous coating. That is, the nanoporous coatings serve to decrease the specular reflectance of at least visible light from the surface of the coated article. In addition, and as will be described in more detail below, the coated articles can exhibit high transmission, low haze, and high durability, among other features.

As stated above, the substrate on which the nanoporous coating is directly or indirectly disposed can comprise a glass or glass-ceramic material. The choice of glass or glass-ceramic material is not limited to a particular composition, as improved reflection-resistance can be obtained using a variety of glass or glass-ceramic compositions. For example, with respect to glasses, the material chosen can be any of a wide range of silicate, borosilicate, aluminosilicate, or boroaluminosilicate glass compositions, which optionally can comprise one or more alkali and/or alkaline earth modifiers. By way of illustration, one such glass composition includes the following constituents: 58-72 mole percent (mol %) SiO₂; 9-17 mol % Al₂O₃; 2-12 mol % B₂O₃; 8-16 mol % Na₂O; and 0-4 mol % K₂O, wherein the ratio

$$\frac{{Al}_{2} {O}_{3} ( mol \% ) + {B}_{2} {O}_{3} ( mol \% )}{\sum modifiers ( mol \% )} > 1 ,$$

where the modifiers comprise alkali metal oxides. Another glass composition includes the following constituents: 61-75 mol % SiO₂; 7-15 mol % Al₂O₃; 0-12 mol % B₂O₃; 9-21 mol % Na₂O; 0-4 mol % K₂O; 0-7 mol % MgO; and 0-3 mol % CaO. Yet another illustrative glass composition includes the following constituents: 60-70 mol % SiO₂; 6-14 mol % Al₂O₃; 0-15 mol % B₂O₃; 0-15 mol % Li₂O; 0-20 mol % Na₂O; 0-10 mol % K₂O; 0-8 mol % MgO; 0-10 mol % CaO; 0-5 mol % ZrO₂; 0-1 mol % SnO₂; 0-1 mol % CeO₂; less than 50 parts per million (ppm) As₂O₃; and less than 50 ppm Sb₂O₃; wherein 12 mol %≦Li₂O+Na₂O+K₂O≦20 mol % and 0 mol %≦MgO+CaO≦10 mol %. Still another illustrative glass composition includes the following constituents: 55-75 mol % SiO₂, 8-15 mol % Al₂O₃, 10-20 mol % B₂O₃; 0-8% MgO, 0-8 mol % CaO, 0-8 mol % SrO and 0-8 mol % BaO.

Similarly, with respect to glass-ceramics, the material chosen can be any of a wide range of materials having both a glassy phase and a ceramic phase. Illustrative glass-ceramics include those materials where the glass phase is formed from a silicate, borosilicate, aluminosilicate, or boroaluminosilicate, and the ceramic phase is formed from β-spodumene, β-quartz, nepheline, kalsilite, or carnegieite.

The glass or glass-ceramic substrate can adopt a variety of physical forms. That is, from a cross-sectional perspective, the substrate can be flat or planar, or it can be curved and/or sharply-bent. Similarly, it can be a single unitary object, or a multi-layered structure or laminate. Further, the substrate optionally can be annealed and/or strengthened (e.g., by thermal tempering, chemical ion-exchange, or like processes).

The nanoporous coating that is disposed, either directly or indirectly, on at least a portion of a surface of the substrate can be formed from a variety of materials. In general, both the nanoporous coating and the coating material generally include a Si-containing component, which facilitates compatibility with the glass or glass-ceramic substrate. The coating material will be selected such that it imparts other desirable properties (e.g., appropriate levels of haze, transmittance, durability, and the like) to the final coated article.

Exemplary coating materials include uncured and partially-cured siloxanes. For the purposes of the present disclosure, these materials can be designated by the general formula [—R₂SiO—]ₙ, wherein each R is independently a hydrogen or hydrocarbon group or moiety. The hydrocarbon group can be a substituted or unsubstituted, linear or branched, chain or cyclic structure having between 1 and 22 carbons. It is important that these materials are not fully cured prior to their application to the substrate, because a fully cured material will not be able to chemically bond to the glass or glass-ceramic substrate nor be able to be applied thinly One illustrative class of such materials includes partially-cured linear alkyl siloxanes (e.g., partially-cured methyl siloxane, partially-cured ethyl siloxane, partially-cured propyl siloxane, and the like).

Another class of exemplary coating materials includes uncured and partially-cured silsesquioxanes. For the purposes of the present disclosure, these materials can be designated by the general formula [—RSiO_{3/2}—]ₙ, wherein each R is independently a hydrogen or hydrocarbon group or moiety. The hydrocarbon group can be a substituted or unsubstituted, linear or branched, chain or cyclic structure having between 1 and 22 carbons. Just as with the siloxanes, it is important that these materials are not fully cured prior to their application to the substrate, because a fully cured material will not be able to chemically bond to the glass or glass-ceramic substrate nor be able to be applied thinly.

Yet another class of exemplary coating materials includes silica precursors. These materials generally undergo a reaction to produce silica (SiO₂). One illustrative class of such materials includes salts or esters of orthosilicic acid (e.g., tetramethyl orthosilicate, tetraethyl orthosilicate, tetrapropyl orthosilicate, tetrakis(dimethylsilyl) orthosilicate, and the like).

In certain embodiments, the coated articles can include a layer interposed between the glass or glass-ceramic substrate and the nanoporous coating material. This optional intermediate layer can be used to provide additional features to the coated article (e.g., glare resistance or anti-glare properties, color, opacity, increased adhesion or compatibility between the nanoporous coating and the substrate, and/or the like). Such materials are known to those skilled in the art to which this disclosure pertains.

Methods of making the above-described coated articles generally include the steps of providing a glass or glass-ceramic substrate, and forming the nanoporous coating on at least a portion of a surface of the substrate. In those embodiments where the optional intermediate layer is implemented, however, the methods generally involve an additional step of forming the intermediate layer on at least a portion of a surface of the substrate prior to the formation of the nanoporous coating. It should be noted that when the intermediate layer is implemented, the surface fraction of the substrate that is covered by the nanoporous coating does not have to be the same as the surface fraction covered by the intermediate layer.

The selection of materials used in the glass or glass-ceramic substrates, nanoporous coatings, and optional intermediate layers can be made based on the particular application desired for the final coated article. In general, however, the specific materials will be chosen from those described above for the coated articles.

Provision of the substrate can involve selection of a glass or glass-ceramic object as-manufactured, or it can entail subjecting the as-manufactured glass or glass-ceramic object to a treatment in preparation for forming the optional intermediate layer or the nanoporous coating. Examples of such pre-coating treatments include physical or chemical cleaning, physical or chemical strengthening, physical or chemical etching, physical or chemical polishing, annealing, shaping, and/or the like. Such processes are known to those skilled in the art to which this disclosure pertains.

Once the glass or glass-ceramic substrate has been selected and/or prepared, either the optional intermediate layer or the nanoporous coating can be disposed thereon. Depending on the materials chosen, these coatings can be formed using a variety of techniques. It is important to note that the coatings described herein (i.e., both the optional intermediate layer and the nanoporous coating) are not free-standing films that can be applied (e.g., via an adhesive or other fastening means) to the surface of the substrate, but are, in fact, physically formed on the surface of the substrate.

In general, the optional intermediate layer can be fabricated using any of the variants of chemical vapor deposition (CVD) (e.g., plasma-enhanced CVD, aerosol-assisted CVD, metal organic CVD, and the like), any of the variants of physical vapor deposition (PVD) (e.g., ion-assisted PVD, pulsed laser deposition, cathodic arc deposition, sputtering, and the like), spray coating, spin-coating, dip-coating, inkjetting, sol-gel processing, or the like. Such processes are known to those skilled in the art to which this disclosure pertains.

In contrast, the nanoporous coating is formed using any of a number of solution-based processes, among which include spray coating, spin-coating, dip-coating, inkjetting, and sol-gel processing. Once again, such processes are known to those skilled in the art to which this disclosure pertains.

Before implementing the solution-based process to form the nanoporous coating, a solution of the coating material must be formed. This step generally involves contacting the coating material, as described above, with a pore-forming material (referred to herein for convenience as a “porogen”) in the presence of a solvent or mixture of solvents, such that the porogen and coating material are dispersed throughout the solvent in a manner that minimizes the formation of colloidal particles or aggregates. Specifically, any colloidal particles or aggregates that exist should be smaller than about 75 nm in its longest cross-sectional dimension. As used herein, the term “longest cross-sectional dimension” refers to the longest single dimension of a given item (e.g., colloidal particle, pore, or the like). Thus, to clarify, when an item is circular, the longest cross-sectional dimension is its diameter; when an item is oval- shaped, the longest cross-sectional dimension is the longest diameter of the oval; and when an item is irregularly-shaped, the longest cross-sectional dimension is the line between the two farthest opposing points on its perimeter.

The porogen can be selected from a variety of amphiphilic organic compounds or polymer materials that will not react with the coating material, solvent, or substrate, and that can be selectively removed from the coating to leave behind the nanoscale pores within the coating. One exemplary class of porogen materials includes nonionic compounds. These materials can encompass, for example, poly(ethylene oxide) alcohols, poly(ethylene glycol) alkyl ethers (e.g., octaethylene glycol octadecyl ether, diethylene glycol hexadecyl ether, decaethylene glycol oleyl ether, and the like), poly(ethylene oxide)-poly(propylene oxide) diblock copolymers, poly(ethylene oxide)-poly(propylene oxide)-poly(ethylene oxide) triblock copolymers (e.g., poloxamers such as those sold commercially under the trade name PLURONIC by BASF), poly(ethylene glycol) esters (e.g., poly(ethylene glycol) sorbitol hexaoleate, poly(ethylene glycol) sorbitan tetraoleate, and the like), and the like.

With respect to the solvent, any of a variety of known solvents can be implemented. The solvent or mixture of solvents can be chosen to maintain a low surface tension in the solution to promote good wetting of the substrate. Those skilled in the art to which this disclosure pertains can readily select an appropriate solvent for dispersing the porogen and coating material. By way of example, specific solvents that can be used include alcohols (e.g., methanol, ethanol, 2-propanol, butanol, and the like), ketones (e.g., acetone, cyclohexanone, and the like), or the like.

Once the solution containing the porogen and coating material dispersed therein has been prepared, the solution can be contacted with the substrate using any of the solution-based processes described above for forming the coating. Next, the substrate-contacted solution can be subjected to a single or two separate treatments (e.g., surface heating, dielectric heating, ozone treatment, solvent extraction, supercritical gas extraction, and the like) to cure the coating material and remove the porogen to form the final nanoporous coating. In exemplary implementations, a low-temperature (i.e., less than or equal to about 350° C.) thermal treatment simultaneously cures the coating material and removes the porogen from the substrate-contacted solution to form the final nanoporous coating.

Once the coated article is formed, it can be used in a variety of applications where the coated article will be viewed by a user. These applications encompass touch-sensitive display screens or cover plates for various electronic devices (e.g., cellular phones, personal data assistants, computers, tablets, global positioning system navigation devices, and the like), non-touch-sensitive components of electronic devices, surfaces of household appliances (e.g., refrigerators, microwave ovens, stovetops, oven, dishwashers, washers, dryers, and the like), vehicle components, and photovoltaic devices, just to name a few devices.

Given the breadth of potential uses for the improved coated articles described herein, it should be understood that the specific features or properties of a particular coated article will depend on the ultimate application therefor or use thereof. The following description, however, will provide some general considerations.

There is no particular limitation on the average thickness of the substrate contemplated herein. In many exemplary applications, however the average thickness will be less than or equal to about 15 millimeters (mm). If the coated article is to be used in applications where it may be desirable to optimize thickness for weight, cost, and strength characteristics (e.g., in electronic devices, or the like), then even thinner substrates (e.g., less than or equal to about 5 mm) can be used. By way of example, if the coated article is intended to function as a cover for a touch screen display, then the substrate can exhibit an average thickness of about 0.02 mm to about 2.0 mm.

In contrast to the glass or glass-ceramic substrate, where thickness is not limited, the average thickness of the nanoporous coating should be less than or equal to about 1 micrometer (μm). If the nanoporous coating is much thicker than this, it will have adverse effects on the haze, optical transmittance, and/or reflectance of the final coated article. In applications where high transmittance and/or low haze is important or critical (in addition to the improved reflection resistance provided by the nanoporous coating), the average thickness of the nanoporous coating should be less than or equal to 500 nm.

The thickness of the optional intermediate layer will be dictated by its function. For glare resistance, for example, the average thickness should be less than or equal to about 200 nanometers. Coatings that have an average thickness greater than this could scatter light in such a manner that defeats the glare resistance properties.

The porosity of the nanoporous coating generally will depend on the amount of porogen implemented during fabrication, and the extent to which the porogen has been removed from the coating. The extent of the porosity of the nanoporous coating must be balanced between too much porosity, which decreases the scratch-resistance and durability of the coating but also results in increased reflection, and too little porosity, which results in increased scratch-resistance and durability of the coating but also in decreased reflection. In general, however, the nanoporous coating will have a porosity that comprises at least about 5 volume percent (vol %) of the total volume of the coating. In implementations where scratch resistance is critical, those skilled in the art will recognize that lower levels of porosity (e.g., less than 60 vol % of the total volume of the coating) will be needed.

In addition, the average longest cross-sectional dimension of the pores should be less than or equal to about 100 nm so as to minimize optical scattering and create a low effective refractive index that is as close to the square root of the refractive index of the substrate as possible. In certain situations, the average longest cross-sectional dimension of the pores can be about 5 nm to about 75 μm.

In general, the optical transmittance of the coated article will depend on the type of materials chosen. For example, if a glass or glass-ceramic substrate is used without any pigments added thereto and/or the nanoporous coating is sufficiently thin, the coated article can have a transparency over the entire visible spectrum of at least about 85%. In certain cases where the coated article is used in the construction of a touch screen for an electronic device, for example, the transparency of the coated article can be at least about 92% over the visible spectrum. In situations where the substrate comprises a pigment (or is not colorless by virtue of its material constituents) and/or the nanoporous coating is sufficiently thick, the transparency can diminish, even to the point of being opaque across the visible spectrum. Thus, there is no particular limitation on the optical transmittance of the coated article itself

Like transmittance, the haze of the coated article can be tailored to the particular application. As used herein, the terms “haze” and “transmission haze” refer to the percentage of transmitted light scattered outside an angular cone of ±4.0° in accordance with ASTM procedure D1003, the contents of which are incorporated herein by reference in their entirety as if fully set forth below. For an optically smooth surface, transmission haze is generally close to zero. In those situations when the coated article is used in the construction of a touch screen for an electronic device, the haze of the coated article can be less than or equal to about 5%.

Regardless of the application or use, the coated articles described herein offer improved reflection resistance relative to similar or identical articles that lack the nanoporous coatings described herein. This improved reflection resistance occurs at least over the visible spectrum (radiation having a wavelength of about 380 nm to about 750 nm). In certain cases, however, the improved reflection resistance occurs for radiation having a wavelength from about 380 nm to about 1000 nm.

The reflection-resistance can be quantified by measuring the specular reflectance of the coated article and comparing it to that of a similar or identical article lacking the nanoporous coating. In general, the coated articles reduce the specular reflectance by at least 15% across the light spectrum of interest relative to similar or identical articles that lack the nanoporous coatings described herein. Stated another way, the specular reflectance of the coated articles are less than or equal to about 85% of that of the uncoated substrate by itself. In certain cases, however, it is possible to reduce the specular reflectance by at least 35% across the light spectrum of interest relative to similar or identical articles that lack the nanoporous coatings described herein.

In general, the nanoporous coating itself will have a specular reflectance of less than about 5% across the visible light spectrum. In some cases, however, the nanoporous coating itself can have a specular reflectance of less than about 1.5% across the visible light spectrum.

The coated articles described herein are capable of exhibiting high durability. Coating durability (also referred to as Crock Resistance) refers to the ability of the nanoporous coating to withstand repeated rubbing with a cloth. The Crock Resistance test is meant to mimic the physical contact between garments or fabrics with a coated article and to determine the durability of the coatings disposed on the substrate after such treatment.

A Crockmeter is a standard instrument that is used to determine the Crock resistance of a surface subjected to such rubbing. The Crockmeter subjects a substrate to direct contact with a rubbing tip or “finger” mounted on the end of a weighted arm. The standard finger supplied with the Crockmeter is a 15 millimeter (mm) diameter solid acrylic rod. A clean piece of standard crocking cloth is mounted to this acrylic finger. The finger then rests on the sample with a pressure of 900 g and the arm is mechanically moved back and forth repeatedly across the sample in an attempt to observe a change in the durability/crock resistance. The Crockmeter used in the tests described herein is a motorized model that provides a uniform stroke rate of 60 revolutions per minute. The Crockmeter test is described in ASTM test procedure F1319-94, entitled “Standard Test Method for Determination of Abrasion and Smudge Resistance of Images Produced from Business Copy Products,” the contents of which are incorporated herein by reference in their entirety.

Crock resistance or durability of the coated articles described herein is determined by optical (e.g., reflectance, haze, or transmittance) measurements after a specified number of wipes as defined by ASTM test procedure F1319-94. A “wipe” is defined as two strokes or one cycle, of the rubbing tip or finger.

In certain implementations, the reflectance of the coated articles described herein varies by less than about 20% after 100 wipes from an initial reflectance value measured before wiping. In some cases, after 1000 wipes the reflectance of the coated articles varies by less than about 20% from the initial reflectance value, and, in other embodiments, after 5000 wipes the reflectance of the coated articles varies by less than about 20% from the initial reflectance value.

The coated articles described herein are also capable of exhibiting high scratch resistance or hardness. The scratch resistance or hardness is measured using ASTM test procedure D3363-05, entitled “Standard Test Method for Film Hardness by Pencil Test,” with a scale ranging from 9B, which represents the softest and least scratch resistant type of film, through 9H, which represents the hardest and most scratch resistant type of film The contents of ASTM test procedure D3363-05 are incorporated herein by reference in their entirety as if fully set forth below

The nanoporous coatings described herein generally have a scratch resistance or hardness of at least HB. In certain implementations, the scratch resistance or hardness can be at least 2B.

In a specific embodiment that might be particularly advantageous for applications such as touch accessed or operated electronic devices, a reflection-resistant coated article is formed using a chemically strengthened (ion exchanged) alkali aluminosilicate flat glass sheet. The chemically strengthened (ion exchanged) alkali aluminosilicate flat glass sheet has a depth of layer greater than or equal to 20 micrometers and exhibits a compressive strength of at least 400 megaPascals (MPa).

The nanoporous coating is formed by first preparing a solution comprising a partially-cured methyl siloxane polymer and a poloxamer porogen dissolved in a solvent, and then spin-coating the solution directly onto one surface of the glass sheet. The alkali aluminosilicate flat glass sheet with the spin-coated solution disposed thereon is then heated to a temperature of less than or equal to about 315° C. to simultaneously cure the methyl siloxane polymer and remove the poloxamer porogen from the curing spin-coated solution.

Advantageously, at such low temperatures, the compressive stress induced by the ion exchange process is not substantially diminished by the heating step. This process beneficially enables the chemically strengthened glass to be coated with the nanoporous reflection-resistant coating, rather than coating the glass with the nanoporous reflection-resistant coating first, followed by chemical strengthening. In the latter case, it is possible that the nanoporous coating could serve as a diffusion barrier to the chemical strengthening step, thereby prohibiting the glass to be strengthened. Thus, the coated surface of the chemically strengthened alkali aluminosilicate flat glass sheet has a depth of layer greater than or equal to 20 micrometers and exhibits a compressive strength of at least 400 MPa after the heat treatment.

The average thickness of the alkali aluminosilicate flat glass sheet is less than or equal to about 1 mm, and the average thickness of the nanoporous methyl siloxane coating is less than or equal to about 100 nm. The nanoporous methyl siloxane coating has a porosity between about 30 vol % and about 55 vol % of the total volume of the coating material, with the average longest cross-sectional dimension of the pores being less than about 50 nm.

Such a coated article can be used in the fabrication of a touch screen display for an electronic device. The coated article can have an optical transmittance of at least about 94% and a haze of less than about 0.1%. During operation, the coated article can exhibit high reflection resistance in that the specular reflectance of the coated article is less than or equal to 7% across a spectrum spanning from about 380 nm to about 1000 nm. As far as the Crock resistance or durability of such a coated article, the specular reflectance varies by less than about 5% after 100 wipes using a Crockmeter from the initial specular reflectance value measured before the first wipe. Further, the specular reflectance varies by less than about 10% from the initial reflectance value after 5000 wipes. Finally, the scratch resistance or hardness of the nanoporous methyl siloxane coating is at least 6H.

In another specific embodiment, a reflection-resistant coated article is formed using a chemically strengthened (ion exchanged) alkali aluminosilicate flat glass sheet. The chemically strengthened (ion exchanged) alkali aluminosilicate flat glass sheet has a depth of layer greater than or equal to 20 micrometers and exhibits a compressive strength of at least 400 megaPascals (MPa).

The nanoporous coating is formed by first preparing a solution comprising a tetraethyl orthosilicate sol-gel precursor having no visible colloids, dissolving a poloxamer porogen into the sol-gel precursor solution, and then spin-coating the combined solution directly onto one surface of the glass sheet. The alkali aluminosilicate flat glass sheet with the spin-coated solution disposed thereon is then heated to a temperature of less than or equal to about 320° C. to simultaneously cure or convert the precursor into silica and remove the poloxamer porogen from the curing spin-coated solution. Again, the compressive stress induced by the ion exchange process is not diminished by the heating step of this process.

The average thickness of the alkali aluminosilicate flat glass sheet is less than or equal to about 1 mm, and the average thickness of the nanoporous methyl siloxane coating is less than or equal to about 100 nm. The nanoporous methyl siloxane coating has a porosity between about 30 vol % and about 55 vol % of the total volume of the coating material, with the average longest cross-sectional dimension of the pores being less than about 50 nm.

Such a coated article can also be used in the fabrication of a touch screen display for an electronic device. The coated article can have an initial optical transmittance of at least about 95% and a haze of less than 0.2%. During operation, the coated article can exhibit high reflection resistance in that the specular reflectance of the coated article is less than or equal to 9% across a spectrum spanning from about 380 nm to about 1000 nm. As far as the Crock resistance or durability of such a coated article, the specular reflectance varies by less than about 3% after 100 wipes using a Crockmeter from the initial specular reflectance value measured before the first wipe. Further, the specular reflectance varies by less than about 8% from the initial reflectance value after 5000 wipes. Finally, the scratch resistance or hardness of the nanoporous silica coating is 6H.

The various embodiments of the present disclosure are further illustrated by the following non-limiting examples.

### EXAMPLES

### Example 1

### Fabrication of Nanoporous Siloxane Coatings on Flat Glass Substrates

About 5 milliLiters (mL) of a commercially available methyl siloxane polymer solution (Honewell Accuglass T-214) was mixed with about 9 mL of anhydrous 2-propanol. About 0.0675 grams of a commercially available block copolymer porogen (BASF Pluronic P103) was dissolved in this mixture. In some cases, mild heat was applied to aid in dissolution of the block copolymer porogen. This solution was spin-coated on a clean alkali aluminosilicate glass substrate at a spin speed of about 2500 revolutions per minute (RPM), and then cured in ambient air at about 315° C.

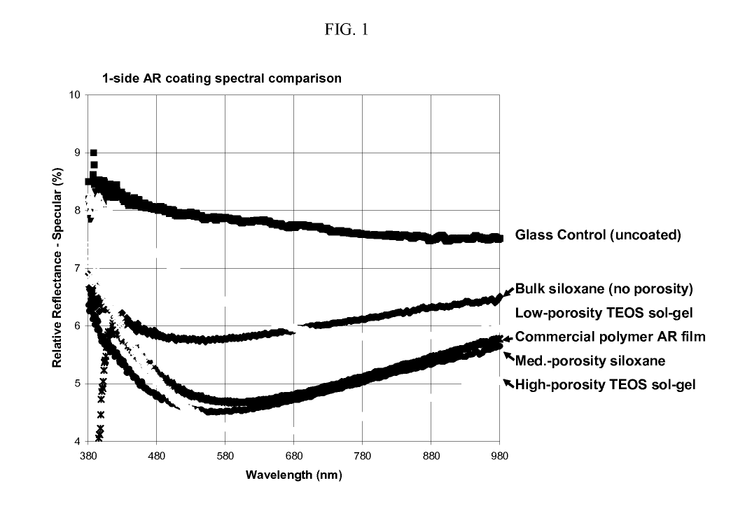

The specular reflectance of a representative coating made in accordance with this example is shown in FIG. 1, and labeled as “Med.-porosity siloxane.” Good low-reflection results were obtained between about 380 nm and 980 nm, indicating nano-porosity and removal of the block copolymer porogen material.

There was no hazy appearance or light scattering visible to the naked eye in either the precursor solutions or final films The coated glass samples were placed in display systems as a cover glass, and the measured contrast under various brightly-lit environments (luminance of fully bright screen divided by luminance of fully dark screen) was found to match or exceed the contrast measured from a bare, uncoated, flat piece of cover glass (this “control” piece of uncoated cover glass also had essentially zero haze or light scattering).

Both the diffuse and total reflection and transmission components were tested for these samples, and it was found that light scattering was minimal to non-existent, as indicated by a transmission haze value of below about 0.2%. This indicated that the pores formed within the film were very small (generally well below about 100 nm) and well-dispersed.

Good durability to normal handling was observed and pencil hardness levels comparable to commercially available polymer anti-reflection films were measured for the nanoporous siloxane-coated glass prepared in accordance with this example.

For a relative comparison of the reflection resistance improvements attributed to the nanoporous coatings, the specular reflectance of an uncoated glass sample is also shown in FIG. 1 (labeled “Glass Control (uncoated)”). As can be seen, the nanoporous siloxane-coated glass articles produced by this example exhibited improved reflection-resistance relative to the substrate alone.

In addition, a coated sample was prepared using the procedure described above, with the exception that no porogen was used. The specular reflectance of this sample, labeled “Bulk siloxane (no porosity)” in FIG. 1, was higher than that of the nanoporous siloxane-coated glass (“Med.-porosity siloxane”) across the entire measured spectrum.

The coatings whose spectra are shown in FIG. 1 are single-side coatings on an alkali aluminosilicate glass substrate. The baseline reflection value of about 4% is the reflection from the uncoated side of the glass. Thus, a reflection of about 5% in FIG. 1 corresponds to a reflection of about 1% from the coated side of the glass. For the nanoporous siloxane-coated glass (“Med.-porosity siloxane”), the specular and total reflection obtained was below about 1% at a wavelength of about 550 nm.

Finally, the specular reflectance of a sample coated with a commercially available polymer anti-reflection film is also shown in FIG. 1 for reference (labeled “Commercial polymer AR film”)

### Example 2

### Fabrication of Nanoporous Silica Coatings on Flat Glass Substrates

Tetraethyl orthosilicate (TEOS) from Aldrich was reacted to form a sol-gel precursor solution according to the following procedure:

About 200 mL of methanol was mixed with about 25 mL of TEOS and about 25 mL of about 0.01 moles per Liter (M) HCl in water, resulting in a pH of about 3. This mixture was stirred under reflux heating for about two hours, yielding sol-gel precursor “AA”. After extracting about 50 mL of the precursor “AA” solution, about 1.5 mL of about 0.1 M NH₄OH in methanol was added to adjust the pH of the remaining solution up to about 3.5. This mixture was then stirred under reflux heating for about 14 hours. This resulted in sol-gel precursor “A”. Both precursor solutions “AA” and “A” were transparent with no evidence of colloid formation visible to the naked eye.

Both precursors “AA” and “A” were independently mixed with a commercially available block copolymer porogen (BASF Pluronic P103) in order to promote nanopore formation. For so-called “low-porosity mixtures,” about 0.048 grams of the porogen were dissolved in about 5 mL of the sol-gel precursor. For so-called “high-porosity mixtures” about 0.192 grams were dissolved in about 5 mL of the sol-gel precursor.

Low-porosity mixtures were spin-coated at about 2000 RPM onto alkali aluminosilicate glass substrates. High-porosity mixtures were further diluted 1:1 with methanol and spin-coated at about 2000 RPM onto alkali aluminosilicate glass substrates. Both were then cured at about 315° C. under ambient atmosphere. Curing at about 300° C. was also found to effectively remove the porogen material, leading to a low-index coating giving good reflection performance.

Good anti-reflection performance was obtained, indicating adequate removal of the porogen. Representative reflection spectra for films made from low-porosity and high-porosity TEOS sol-gel mixtures are also shown in FIG. 1. As with the coated articles of EXAMPLE 1, the coated articles showed good durability to normal handling.

In the case of the low-porosity TEOS samples, the specular and total reflection obtained from the side of the glass coated with the silica films was below about 1% at about 550 nm wavelength, and below about 0.5% at about 600 nm.

There was no hazy appearance or light scattering visible to the naked eye in either the precursor solutions or final films The coated glass samples were placed in display systems as a cover glass, and the measured contrast under various brightly-lit environments (luminance of fully bright screen divided by luminance of fully dark screen) was found to match or exceed the contrast measured from a bare, uncoated, flat piece of cover glass (this “control” piece of uncoated cover glass also had essentially zero haze or light scattering).

Both the diffuse and total reflection and transmission components were tested for these samples, and it was found that light scattering was minimal to non-existent, as indicated by a transmission haze value of below about 0.2%. This indicated that the pores formed within the film were very small (generally well below about 100 nm) and well-dispersed.

While the embodiments disclosed herein have been set forth for the purpose of illustration, the foregoing description should not be deemed to be a limitation on the scope of the disclosure or the appended claims. Accordingly, various modifications, adaptations, and alternatives may occur to one skilled in the art without departing from the spirit and scope of the present disclosure or the appended claims.

What is claimed is:

1. A coated article, comprising:
a glass or glass-ceramic substrate; and
a nanoporous Si-containing coating having an average thickness of less than or equal to about 1 micrometer disposed on at least a portion of a surface of the glass or glass-ceramic substrate;
wherein the nanoporous Si-containing coating has a porosity comprising at least 5 volume percent of a total volume occupied by the nanoporous Si-containing coating;
wherein an average longest cross-sectional dimension of pores in the nanoporous Si-containing coating is less than or equal to about 100 nanometers;
wherein the coated article has a specular reflectance that is less than or equal to about 85 percent of a specular reflectance of the glass or glass-ceramic substrate alone across a visible light spectrum;
wherein the nanoporous Si-containing coating has a specular reflectance of less than 5 percent across the visible light spectrum.

2. The coated article of claim 1, further comprising an intermediate layer interposed between the glass or glass-ceramic substrate and the nanoporous Si-containing coating.

3. The coated article of claim 1, wherein the intermediate layer comprises a glare-resistant coating, a color-providing composition, an opacity-providing composition, or an adhesion or compatibility promoting composition.

4. The coated article of claim 1, wherein the glass or glass-ceramic substrate comprises a silicate glass, borosilicate glass, aluminosilicate glass, or boroaluminosilicate glass, which optionally comprises an alkali or alkaline earth modifier.

5. The coated article of claim 1, wherein the glass or glass-ceramic substrate is a glass-ceramic comprising a glassy phase and a ceramic phase, wherein the ceramic phase comprises β-spodumene, β-quartz, nepheline, kalsilite, or carnegieite.

6. The coated article of claim 1, wherein the glass or glass-ceramic substrate has an average thickness of less than or equal to about 2 millimeters.

7. The coated article of claim 1, wherein the nanoporous Si-containing coating comprises a cured siloxane, a cured silsesquioxane, or silica.

8. The coated article of claim 1, wherein the coated article comprises a portion of a touch-sensitive display screen or cover plate for an electronic device, a non-touch-sensitive component of an electronic device, a surface of a household appliance, or a surface of a vehicle component.

9. A coated article, comprising:
a chemically-strengthened alkali aluminosilicate glass substrate; and
a nanoporous Si-containing coating having an average thickness of less than or equal to about 100 nanometers disposed directly on at least a portion of a surface of the chemically-strengthened alkali aluminosilicate glass substrate;
wherein the chemically-strengthened alkali aluminosilicate glass substrate has a compressive layer having a depth of layer greater than or equal to 20 micrometers exhibiting a compressive strength of at least 400 megaPascals both before and after the nanoporous Si-containing coating has been disposed thereon;
wherein the nanoporous Si-containing coating has a porosity comprising between about 30 volume percent and about 55 volume percent of a total volume occupied by the nanoporous Si-containing coating;
wherein an average longest cross-sectional dimension of pores in the nanoporous Si-containing coating is less than or equal to about 50 nanometers;
wherein the coated article has a specular reflectance of less than 7 percent across a visible light spectrum;
wherein the coated article has an optical transmission of at least about 94 percent;
wherein the coated article has a haze of less than or equal to about 0.1 percent when measured in accordance with ASTM procedure D1003;
wherein the coated article exhibits a scratch resistance of at least 6H when measured in accordance with ASTM test procedure D3363-05.

10. The coated article of claim 9, wherein the specular reflectance of the coated article varies by less than about 5 percent after 100 wipes using a Crockmeter, and varies by less than about 10 percent after 5000 wipes using the Crockmeter from an initial measurement of the specular reflectance of the coated article before a first wipe using the Crockmeter.

11. A method of making a coated article, the method comprising:
providing a glass or glass-ceramic substrate;
preparing a solution comprising a Si-containing coating material and a pore forming agent, wherein the solution comprises no colloidal particles or aggregates having a longest cross-sectional dimension greater than about 75 nanometers;
disposing the solution on a surface of the glass or glass-ceramic substrate; and
heating the solution-coated substrate at a temperature of less than or equal to about 350 degrees Celsius to both cure the Si-containing coating material and remove the pore forming agent from the solution, thereby forming a nanoporous Si-containing coating on the surface of the glass or glass-ceramic substrate.

12. The method of claim 11, further comprising forming an intermediate layer on at least a portion of the surface of the glass or glass-ceramic substrate prior to disposing the solution thereon, wherein the intermediate layer comprises glare-resistant coating, a color-providing composition, an opacity-providing composition, or an adhesion or compatibility promoting composition.

13. The method of claim 11, wherein the nanoporous Si-containing coating has a porosity comprising at least 5 volume percent of a total volume occupied by the nanoporous Si-containing coating; wherein an average longest cross-sectional dimension of pores in the nanoporous Si-containing coating is less than or equal to about 100 nanometers; wherein the coated article has a specular reflectance that is less than or equal to about 85 percent of a specular reflectance of the glass or glass-ceramic substrate alone across a visible light spectrum; and wherein the nanoporous Si-containing coating has a specular reflectance of less than 5 percent across the visible light spectrum.

14. The method of claim 11, wherein the Si-containing coating material comprises an uncured or partially-cured siloxane, an uncured or partially-cured silsesquioxane, or a silica sol-gel precursor.

15. The method of claim 11, wherein the nanoporous Si-containing coating comprises a cured siloxane, a cured silsesquioxane, or silica.
